(19) United States
(12) Patent Application Publication
(10) Pub. No.: US 2005/0136965 A1
(43) Pub. Date: Jun. 23, 2005

(54) Estimating base station power in a CDMA radio communications network

(76) Inventors: Benoit Fourestie, Paris (FR); Sana Ben Jamaa, Paris (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/954,663

(22) Filed: Oct. 1, 2004

(30) Foreign Application Priority Data
Oct. 2, 2003 (EP) 03292443.3

(51) Int. Cl. H04Q 7/20

(52) U.S. Cl. 455/522

(57) ABSTRACT

The total powers transmitted and received by a given base station in a CDMA network, as a function of the sum of powers of channels dedicated to mobile terminals having active links with the given base station, are estimated by assuming the total powers transmitted by and received from the neighboring base stations at the given base station equal those of the given base station. Interstation to intrastation and intrastation to interstation interference factors are determined independently of the total powers transmitted to and received by the base stations and are a function only of path attenuation between mobile terminals in given positions and the base stations. The total transmitted and received powers of the given base station are estimated as a function of the ascertained interference factors, to circumvent a large number of iterations for a given power accuracy.

### FIELD OF THE INVENTION

The present invention relates to planning and simulating a digital cellular radiocommunications network.

### BACKGROUND ART

More specifically, it relates to estimating the base station power at a given site of this station in a digital cellular radiocommunications network having Coded Division Multiple Access (CDMA). For instance the network is a wideband FDD-W-CDMA kind (Frequency Division Duplex Wideband CDMA), of the third generation (3GPP) of UMTS (Universal Mobile Telecommunications System) type.

The total interference powers received in an uplink from mobile radiocommunication terminals, also called “mobiles”, may be estimated by iteration simulation methods for CDMA networks and the like so as to attain computational convergence of the estimated powers. The following literature may be considered which cites consecutive iterations until the resulting powers converge:
A framework for uplink power control in cellular radio systems, Roy D. Yates, IEEE Journal on Selected Areas in Communications, vol. 13, #7, pp 1341-7, September 1995, and
Convergence theorem for a general class of power control algorithms, Kin Kwong Leung et al., IEEE International Conference on communications, vol. 3, pp 811-15, June 2001.

European patent application 1335616 relates to planning and evaluating the downlink coverage in a radio CDMA network and more specifically to estimating the transmission power of a base station (cell) by iterating its traffic channel powers. During the first iteration, the transmitted powers from these base stations will be the respective initial values. Several iterations are required before a base station's power will converge.

However the downlink iterative power estimates incur the drawback of being lengthy before reaching the convergence of the computed power loop. Moreover this iterative procedure precludes testing a sufficient number of parameters defining the base stations and the mobiles with a reasonable time.

Again such an iterative procedure cannot be applied properly to estimating the total power transmitted by the given base station when one of said mobiles operates in the macrodiversity mode, that is when it keeps up simultaneous, active links with several base stations.

The objective of the present invention is to create a method of estimating the total power transmitted in a CDMA network at given the mobile positions, said method considerably reducing the number of iterations required to determine said total power at a given accuracy, illustratively for the purpose of rapidly selecting the highest-performing of available sites of a base station in the sense of network capacity vs. a given quality of service.

### SUMMARY OF THE INVENTION

To attain this objective, a method of estimating the total power transmitted by a given base station in a type CDMA radiocommunications network as a function of the sum of the powers of channels dedicated to mobiles in given positions and having active links to the given base station following a prior determination of path attenuation for the active links between arrayed mobiles in given positions and base stations in the vicinity of the given base station, is characterized by assuming that total powers transmitted by the neighboring base stations are assumed to be equal to the total power transmitted by the given base station, the method comprising determining interstation to intrastation interference factors independently of the total powers transmitted by the given base station and by the neighboring base stations and each equal to the path attenuation ratio determined for an active link between a respective mobile in a given position and the given base station and to a sum of inverses of path attenuation predetermined between the respective mobile in a given position and the neighboring stations, and estimating the total power transmitted by the given base station as a function of the sum of the determined interstation to intrastate interference factors.

In the above method, the estimate of the total transmitted power advantageously requires no iteration at all.

Even though transmitted total powers of these base stations are each estimated as being sufficiently near the powers at network equilibrium, it may be desirable in some cases to refine the preceding estimate by adding at least one ensuing iteration. The total powers transmitted by the neighboring base stations are estimated by considering each of them a given base station, whereupon again the interstation to intrastation interference factors are estimated as a function again of the total transmitted powers both from the given base station and of the neighboring base stations as estimated, and again the total power transmitted by the given base station is estimated as a function of the previously determined interstation to interstation to intrastation interference factors.

The invention preferably comprises one or several consecutive estimates of the total power transmitted by the given base station at a given accuracy, and as a result very numerous iterations or complex matrix calculations are circumvented and in this manner the estimate time is considerably reduced. The invention's number of iterations is commensurately lower as the accuracy with which the total transmitted power is lower, and it is substantially lower than in the state of the art at a given accuracy.

When a mobile operates in the macro-diversity mode, the signal to interference ratio for a downlink to said mobile on which depends the total power transmitted by the given base station may be replaced by the sum of signal to interference ratios that are determined for all the active downlinks to the mobile operating in the macro-diversity mode, each given signal to interference ratio depending on sums of the downlink attenuation ratios relating to the active downlinks to the mobile operating in the macro-diversity mode.

The invention preferably furthermore estimates the total interference power received from a given base station in a CDMA type network as a function of the sum of the interference powers received from channels dedicated to mobiles in given positions having active links with the given base station. It is assumed in such an estimate that the total interference powers received from the neighboring base stations are equal to the total interference power received from the given base station within the value of active link noise power, and intrastation to interstation interference factors are determined independently of the total interference powers received by the given base station and from the neighboring base stations, while depending only each on previously determined path attenuations of the active links between the mobiles in given positions and the given base station and the active links between the mobiles the neighboring base stations, said factors depending furthermore on a previously determined path attenuation for an active link between a mobile is a given position and the given base station, the total interference power received by the given base station being estimated as a function of the given intrastation to interstation interference factors.

If in some instance it is desired to refine the preceding estimate of the total received interference power, at least the following additional iteration shall be employed which consists in estimating the total interference powers received by the neighboring base station by considering each of these neighboring base stations as a given base station, by again determining the intrastation to interstation interference factors as a function again of the total powers received by the given base station and from the estimated neighboring base stations, and by again estimating the total interference power received by the given base station as a function of the intrastation to interstation interference factors that were previously determined.

### BRIEF DESCRIPTION OF THE DRAWINGS

Other features and advantages of the present invention are elucidated in illustrative and non-limiting manner in the description below of several preferred embodiments of the invention in relation to the corresponding appended drawings.

FIG. 1 is a schematic diagram including the vicinity of a given base station in a W-CDMA radiocommunications network,

FIG. 2 is a flow diagram of an algorithm of the main stages of the power estimating method of the invention, and

FIG. 3 is a flow diagram of an algorithm for a two-iteration power estimating stage of the invention.

### DETAILED DESCRIPTION OF THE DRAWINGS

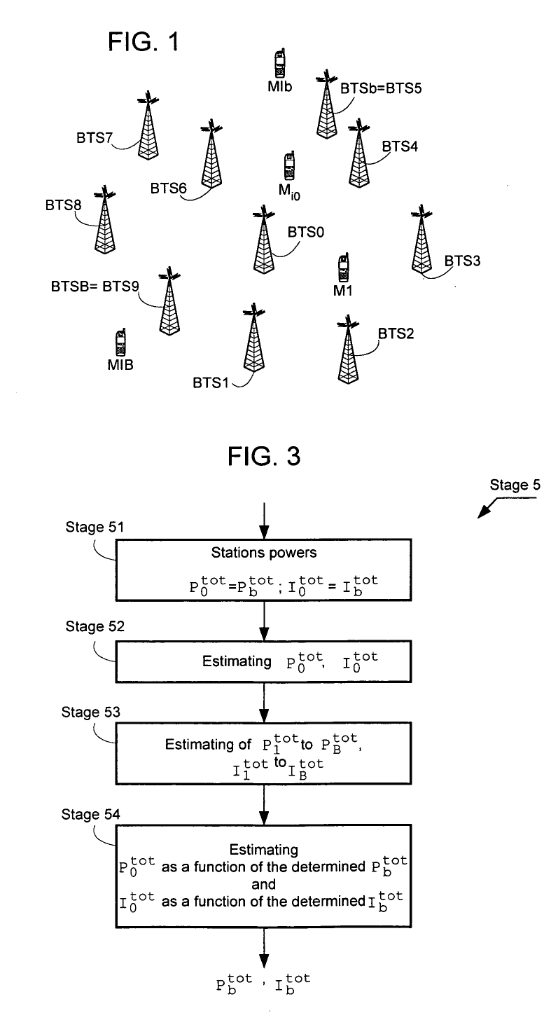

In FIG. 1, a given base station BTS₀ (node B in the UMTS vocabulary) in a wideband cellular radiocommunication network of the W-CDMA type is surrounded by B neighboring base stations BTS_{b} where the subscript bε{1, B}. A base station BTS_{b} is considered “near” the given base station BTS₀ associated with the subscript b=0 when the neighboring station BTS_{b} is situated within a predetermined radius from the given station and the given station receives interference power from a mobile radiocommunications terminal situated at the station BTS_{b} such that the signal to interference ratio (SIR) in the given station is larger than a minimum signal to interference ratio. The number B of neighboring stations therefore varies from one station to the next as a function of the terrain around the given station.

The loads of the downlinks DL are defined as follows in the given base station

$${L}_{DL} = {P}_{0}^{tot} / {P}_{0}^{max}$$

where P₀^{tot} denotes the total power transmitted by the given base station BTS₀ and

$${P}_{0}^{max}$$

denotes the maximum total power transmitted by the station BTS₀. As regards uplinks UL to the given base station, the load is given by

$${L}_{UL} = {I}_{0}^{tot} / ( {I}_{0}^{tot} + N )$$

where I₀^{tot} is the total interference power received by the base station BTS₀ and N₀ denotes the thermal noise power in the links.

The method estimates the total transmitted power P₀^{tot} and the total received interference I₀^{tot} of the given base station BTS₀ at several of its available sites within a predetermined environment. Each base station BTS_{b} where bε{0, B} communicates with respective mobile radiocommunications terminals M_{b} where the subscript ibε{1, Ib}, the integers I0 through IB associated with the stations BTS₀ through BTS_{b} being different a priori.

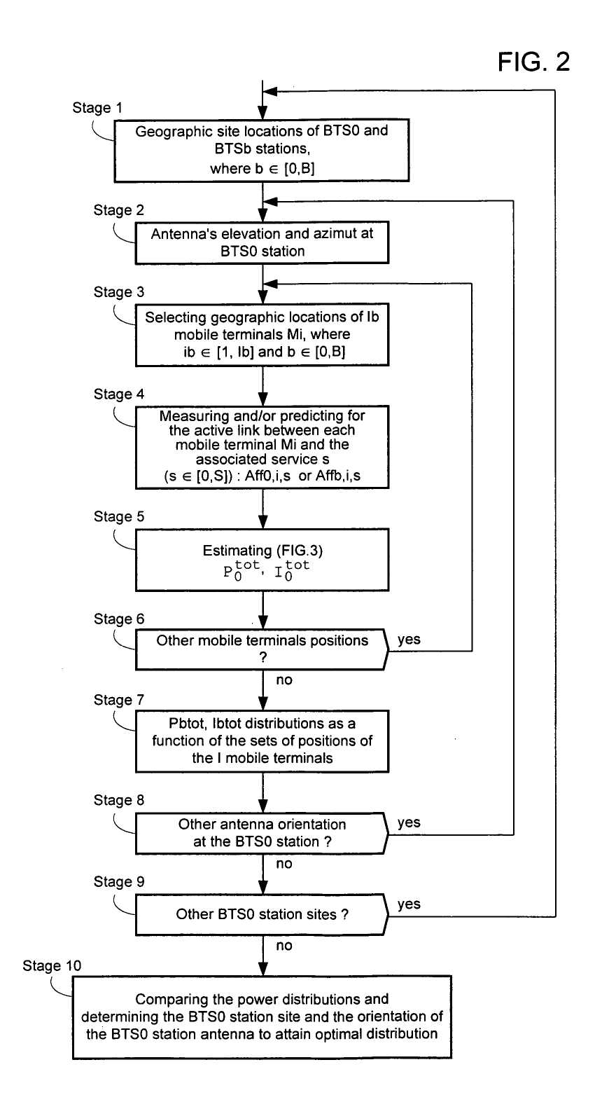

As shown in FIG. 2, the method of the invention to estimate power is performed by a computer having integrated software causing the computer to execute stages S1 through A10.

The computer contains or is able to access a database wherein geographic and power data were recorded in particular during prior stages S1 through S4. In stage S1, the geographic coordinates of the site of each base station BTS₀ through BTS₄ such as site longitude, latitude and altitude are recorded by means of the computer mouse placing the site on a display map which was previously digitized, cellularized and entered into the computer. The site and the azimuth of a transceiver antenna of the given base station BTS₀ are selected in stage S2; other features of the given station also are entered, for instance the radiation lobe of the antenna. The mobiles M_{1b} through M_{1b} communicating with each station BTS_{b} also are put in given positions on this displayed map and the coordinates of their selected positions also are entered in stage S3.

The active links between the mobiles and the base station are defined in stage S4; a mobile communicates only with one station at a time and therefore accepts only active link, whereas a base station may simultaneously communicate with several mobiles and therefore accepts several active links. The path attenuation Att_{b, ib} of an active link between a mobile M_{ib} in a given position to one (BTS_{b}) of the base stations BTS₀ through BTS_{B} is determined being the ratio of a predetermined power transmitted by said base station BTS_{b} operating alone as transmitter to the power of the radioelectric field received for instance at the position of the mobile M_{ib} by actual measurement on the ground or by prediction from a known propagation model that was entered into the computer beforehand. Path attenuation depends on topography, distance from the given base station BTS₀ and latter's positions and on the neighboring base stations selected in stage S1.

A number of services such as telephony (voice), videophony, still image transmission, short messages SMS or multimedia messages MMS are offered at different rates in a W-CDMA network. Services S are predetermined in this manner with a subscript s designating a particular one, namely sε{1, S}. The path attenuations Att_{b, ib} for the active links between the mobiles and the base stations are independent of said services.

Target signal to interference ratios Yₛ^{DL} and Yₛ^{UL} are estimated beforehand respectively for a downlink DL from a base station to a mobile and an uplink UL from a mobile to a base station. The target signal to interference ratio Yₛ^{DL} represents a lower limit below which a mobile no longer receives sufficient power from a station to appropriately process a signal transmitted from said station. The target signal to interference ratio Yₛ^{UL} is a lower limit below which a station no longer receives sufficient power from a mobile to appropriately process a signal transmitted from said mobile. These target ratios are involved in power controls in the mobiles and the stations.

In practice the stages S2, S3 and S4 selecting antenna orientations, mobile positions, active links and services for the active links are iterative, as shall be shown with respect to the next stages S6 and S8. The path attenuations Att_{b, ib} preferably are evaluated beforehand and entered into the database for all possible links between the base stations BTS₀ through BTS_{B} in order to simulate a large number of WCDMA network configurations near the given base station of which the available sites are to be researched.

If called for, beyond stage S4, the given base stations of which the path attenuations were evaluated in relation to all mobile in given positions that exceed a high, predetermined path attenuation threshold are eliminated from being neighboring stations in the power estimate carried out in the next stage S5,

The total power P₀^{tot} which is transmitted by the given base station BTS₀ and which represents the capacity of a downlink DL combining the downlinks selected in stage S4 and relating to the mobile Mᵢ₀ such that iOε{1, I0} is estimated by means of the invention by assuming that the total transmitted powers P₁^{tot} and P_{B}^{tot} of the neighboring base stations a priori will equal P₀^{tot}. This assumption implies that the network load is locally uniform. This hypothesis reduces the number of power unknowns in the estimate of power transmitted by the given base station which is to be analyzed and it allows analytically expressing the estimated transmitted power from the given base station.

The total power P₀^{tot} transmitted by the given base station BTS₀ is determined by the sums of powers P_{CCH} of the channels jointly transmitting in said given base station, except for the synchronizing channel, and by the power P_{SCH} of the synchronizing channel when the given base station is transmitting and by the sum of the powers of the channels dedicated to the mobile having active links with the given base station BTS₀ and linearly depending on orthogonality factorsₛ for the service codes for downlink such that αₛε[0,1], and a spectral noise density N₀ In an active link. Be it borne in mind that the powers of the physical channels that are common to the base stations BTS₀ through BTS_{B} are different a priori and the powers of the synchronizing channels of the base stations BTS₀ through BTS_{B} are different a priori in spite of the hypothesis of equality between the total transmitted powers P₀^{tot} through P₀^{max} of all base stations.

In the invention, the total power P₀^{tot} transmitted by given base station BTS₀ is estimated using the following formula

$${P}_{0}^{tot} = \frac{{P}_{CCH} + {P}_{SCH} + {\sum }_{s ∈ \{ 1 , S \}} {β}_{s} {\sum }_{i0 ∈ \{ 1 , I0 \}} ( ( 1 - {α}_{s} ) {P}_{SCH} + {N}_{0} {Att}_{0 , i0} )}{1 - {\sum }_{s ∈ \{ 1 , S \}} {β}_{s} {\sum }_{i0 ∈ \{ 1 , I0 \}} ( {F}_{i0} + {α}_{s} )}$$

In the preceding formula, the total transmitted power P₀^{tot} depends on the following parameter

$${β}_{s} = \frac{{γ}_{s}^{DL}}{1 + {α}_{s} {γ}_{s}^{DL}}$$

which is a function of the target signal to interference ratio Yₛ^{DL} for a downlink DL with the service s and of an interstation to intrastation interference factor F_{I0} which equals the ratio of the sum of the interferences of the neighboring stations to the interference of the base station BTS₀ for a respective mobile M_{I0} in a given position:

$${F}_{i0} = {Att}_{0 , i0} ( {\sum }_{b ∈ ( 1 , B )} 1 / {Att}_{b , i0} )$$

The factor F_{I0} represents the interference—of an active link between the respective mobile in a given position M_{I0} and the given base station BTS₀—with all the links between the respective mobile M_{I0} in a given position and the neighboring base stations BTS1 through BTS_{B}.

In the absence of local uniformity of the total powers transmitted by the neighboring stations, the factor F_{I0} depends on the total transmitted powers P₀^{tot} through P_{B}^{tot} of the base stations, namely as follows

$${F}_{i0} = \frac{{Attf}_{0 , i0}}{{P}_{0}^{tot}} ( {\sum }_{b ∈ ( 1 , B )} {P}_{b}^{tot} / {Att}_{b , i0} )$$

The powers P₀^{tot} through P_{B}^{tot} being unknown, the uniformity hypothesis of the invention simplifies the expression for F_{I0}.

As shown in FIG. 3, in a higher accuracy embodiment variation, the stage S5—according to the local uniformity hypothesis S51 of the total transmitted powers and the estimate 52 of the total transmitted power P₀^{tot} through P_{B}^{tot} of the given base station—also comprises an estimate of the total transmitted powers from the neighboring base stations BTS₁ through BTS_{B}, using formulas which are similar to the above one, by considering each of the neighboring base stations being a given base station, in a stage S53. Next the hypothesis of local power uniformity as transmitted by the neighboring base stations is abandoned in a stage S54 in order to explicitly introduce the powers P₁^{tot} through P_{B}^{tot} that were estimated just above in the determination of the interstation to intrastation interference factors F_{I0}, with i0, {1, i0}, said factors being stated as

$${F}_{i0} = \frac{{Att}_{0 , i0}}{{P}_{0}^{tot}} ( {\sum }_{b ∈ ( 1 , B )} {P}_{b}^{tot} / {Att}_{b , i0} )$$

The total power transmitted by the given base station BTS₀ is estimated again by means of the preceding formula by introducing the factors F_{I0}, where i0, {1, I0} as a function of the total powers transmitted from the given base station and the neighboring base stations that were estimated above in order to refine the estimate of the total power transmitted from the given base station. If other iterations are carried out, each introducing the values of the transmitted total powers of the base stations that were estimated above into the interference factors, next these factors being introduced into the formulas of the total powers transmitted by the neighboring base stations, then again determining the factors F_{I0}, where i0, {1, I0}, of the given base station and its total transmitted power, then it becomes clear that these iterations are needless because the value of the transmitted total power virtually remains unmodified.

Consequently and thanks to the hypothesis of the uniformity of the total powers transmitted by the neighboring stations being equal to the power from the given station, the convergence shall be very quickly attained by a single estimate or optionally by several estimates of transmitted total power for the sake of higher accuracy, as a result of which the time required to attain a given accuracy of estimate shall have been considerably reduced.

Depending on the total transmitted powers determined for the given base station and the neighboring base stations, the transmitted powers of the dedicated traffic channels in the mobile active links will be determined by the following formula regarding a mobile M_{I0} linked for a service s to the base station BTS₀:

$${P}_{TCH , i0 , s}^{0} = {β}_{s} ⌊ ( 1 - {α}_{s} ) {P}_{SCH} + ( {α}_{s} + {F}_{i0} ) {P}_{0}^{tot} + {N}_{0} {Att}_{0 , i0} ⌋$$

In a variation, the service orthogonality factors αₛ are constants.

In another embodiment of the present invention, a mobile operates in the macro-diversity mode according to the UMTS standard. When operating in macrodiversity, the mobile simultaneously sets up and maintains several radio links with several base stations. The above formula for the total transmitted power P₀^{tot} of the given base station BTS₀ will then be corrected by assuming that the mobile in the macrodiversity mode in the form of a rake receiver combines the received signals according to MRC (Maximum Ratio Combining) by replacing the signal to interference ratio for the for the downlink of the mobile operating in macrodiversity and with service s, by

$${γ}_{s}^{DL} = {\sum }_{l ∈ ( 1 , L )} {ξ}_{s , 1}^{DL}$$

In the above formula,

$${ξ}_{s , 1}^{DL}$$

denotes the target signal to interference ratio for one downlink I of the L active downlinks to the mobile operating in macrodiversity by considering the mobile equivalent to L “mobiles” each having a unique link with a respective station BTS₁ where Iε, (1, L). This latter expression indicates that the sum of the signal to interference ratios resulting from the multiple active links must equal the signal to interference ratio Yₛ^{DL} of the service s for the case of macrodiversity.

Moreover this expression allows estimating separately the received total powers regarding each base station BTS₀ through BTS_{B}. It is equivalent to the mobile operating in macrodiversity being divided into as many mobiles as there are active links to the base stations.

By resorting to the above hypotheses, it can be shown that the signal to interference ratio SIR—which is modified for the first link I=1 of the mobile operating in the macrodiversity mode relative to the station BTS_{I}=BTS₁, where I≦L—is written as

$${ξ}_{s , 1}^{DL} = \frac{{Y}_{s}^{DL}}{{a}_{s} + {\sum }_{{1 ∈ \{ 1 , L \}}_{1 \neq j }}^{} \frac{{Att}_{1 , l1}}{{Att}_{1 , 0}}} / ( \frac{1}{{a}_{s} + {\sum }_{{1 ∈ \{ 1 , L \}}_{1 \neq i }}^{} \frac{{Att}_{1 , l1}}{{Att}_{1 , B}}} + … + \frac{1}{{a}_{s} + {\sum }_{{1 ∈ \{ 1 , L \}}_{1 \neq L }}^{} \frac{{Att}_{L , iL}}{{Att}_{1 , i1}}} )$$

The other signal to interference ratios for I=2 to I=L are modified by permutating the subscripts.

This expression depends only on path attenuation ratios of the active links. These path attenuations being known, the signal to interference ratio Yₛ^{DL} for downlinks relating to the service s and to the mobile operating in macrodiversity is then determined directly, eliminating any iteration.

As regards the uplink UL to the given base station BTS₀ joining the uplinks selected in stage S4 to the mobiles Mi0 where i0ε{1,I0}, the total interference power I₀^{tot} received by the given base station BTS₀ is estimated assuming, similarly to the hypothesis governing the downlink DL, that the total interference powers I_{I}^{tot} through I_{B}^{tot} received by the neighboring base stations BTS₁ through BTS_{B} are a priori equal to the power I₀^{tot} except for the noise power N₀. This consideration amounts to considering the received total interferences in the network being equal and reducing to one the number of unknowns affecting interference.

The total interference power t₀^{tot} received by the BTS₀ station is estimated from the powers transmitted by the mobiles through the active links, taking into account that the ratio of power transmitted by a mobile in service's to the total interference power I₀^{tot} received by the given station BTS₀ must be larger than the target signal to interference ratio Yₛ^{UL} in an uplink at service s, and by summing all powers received from the mobiles having active links with the given base station BTS₀ and interfering with the active links of the neighboring base stations BTS₁ through BTS_{B} and hence depending linearly on the path attenuations in said active links.

In the present method, the total interference power I₀^{tot} of the given received base station BTS₀ is estimated by the following formula:

$${I}_{0}^{tot} = \frac{( {\sum }_{s ∈ \{ 1 , S ]}^{} \frac{{Y}_{s}^{UL}}{1 + {Y}_{s}^{UL}} {\sum }_{{lb ∈ \{ 1 , lb \}}_{b ∈ \{ 0 , B \} }}^{} \frac{{Att}_{b , lb}}{{Att}_{0 , i0}} ) {N}_{0}}{1 - {\sum }_{s ∈ \{ l , S \}} \frac{{Y}_{s}^{UL}}{1 + {Y}_{s}^{UL}} {\sum }_{{lb ∈ \{ 1 , lb \}}_{bc ( 0 , B )}} \frac{{Att}_{b , lb}}{{Att}_{0 , i0}}}$$

Be it borne in mind that the uniformity of powers hypothesis is used only for the intrastation to interstation interference factor according to the path attenuation ratios relating to all active links between mobiles in given positions M_{Ib} and all the base stations BTS₀ through BTS_{B} and to path attenuation relating to an active link between a respective mobile Mᵢ₀ in a given position and the given base station BTS₀:

$${F}_{t0}^{UL} = \frac{1}{{Att}_{0 , i0}} {\sum }_{{lb ∈ \{ 1 , lb \}}_{b ∈ \{ 0 , B \}}} {Att}_{b , lb}$$

In the absence of the local uniformity hypothesis relating to the received total interference powers, the above factor F_{I0}^{UL} will be a function of the total received interference powers I₀^{tot} through I_{B}^{tot} of the base stations as follows:

$${F}_{l0}^{UL} = \frac{1}{{Att}_{0 , lb} ( {I}_{0}^{tot} + {N}_{0} )} {\sum }_{{lb ∈ \{ 1 , lb \}}_{b ∈ \{ 0 , B \}}} {Att}_{b , lb} ( {I}_{b}^{tot} + {N}_{0} )$$

The interference powers I₀^{tot} through I_{B}^{tot} being unknown, the uniformity hypothesis in the invention simplifies the expression of the factor F_{I0}^{UL}.

FIG. 3 furthermore shows that according to the higher accuracy embodiment mode, the stage S5 comprises—according to the local uniformity hypothesis S51 of the received total interference powers and the estimate S52 of the total interference power I₀^{tot} of the given base station—an estimate of the total interference powers I₀^{tot} through I_{B}^{tot} received from the neighboring base stations using formulas similar to the preceding one, considering each of the neighboring base stations as a given base station, in stage S53. Hence the local uniformity hypothesis relating to the powers received by the neighboring is abandoned in stage S54 in order to explicitly introduce the powers I₀^{tot} through I_{B}^{tot} just estimated in the determination of the factors F_{I0}^{UL} where I0ε{1, I0} that are expressed as follows:

$${F}_{l0}^{UL} = \frac{1}{{Att}_{0 , lb} ( {I}_{0}^{tot} + {N}_{0} )} {\sum }_{{lb ∈ \{ 1 , lb \}}_{b ∈ \{ 0 , B \}}} {Att}_{b , lb} ( {I}_{b}^{tot} + {N}_{0} )$$

The total interference power received by the given base station BTS₀ again is estimated according to the preceding formula by introducing the factors F_{I0}^{UL} where i0ε{1, I0} as a function of the total interference powers received by the given base station and by the neighboring base stations (previously estimated) in order to refine the estimate of the total interference received by the given base station. If other iterations are carried out each introducing the values of the received interference powers previously estimated of the base stations in the interference factors for uplinks, then next these factors in the formulas of the total interference powers received by the neighboring base stations, and again determining the factors F_{ID}^{UL} of the given base station and the total interference power that latter received, it is clear that these iterations are needless because the total received interference power virtually is unchanged, entailing the same results as for the total transmitted power as regards speed of convergence and estimating.

Following the estimate of the total power transmitted and the total interference power received by the given base station BTS₀, other values of P₀^{tot} and I₀^{tot} are estimated in stage S6 for other services and for other mobile in given positions in order to display distribution plots of the transmitted and received powers as a function of sets of mobile positions and sets of services in stage S7.

Similar estimates are then carried out in stage S8 for different orientations in elevation and in azimuth of the antenna of the given base station BTS₀. Then, optionally, the preceding estimates are reiterated for other available sites of the given base station BTS₀ in stage S9.

Lastly, in stage S10, the distributions of total transmitted power and of total received interference power that were developed at stages S7 are compared and analyzed in order to select the site of the given base station BTS₀ having the most favorable antenna orientation of this station among proposed sites.

In the course of network development, the method may be resorted to again to again estimate the powers transmitted and received by base stations in particular as a function of an increase in traffic.

Also several consecutive estimates may be carried out in random manner on correlated mobile positions to allow monitoring network development as a function of the mobiles displacement and of their hookups and disconnections.

1. A method of estimating the total power transmitted by a given base station in a CDMA type radiocommunications network as a function of the sum of powers of channels dedicated to mobile terminals in given positions having active links to the given base station, following prior determination of path attenuations in active links between mobile terminals in given positions and the given base station and in active links between mobile terminals in given positions and base stations which are near the given base station, wherein
the total powers transmitted by the neighboring base stations are assumed to equal the total power transmitted by the given base station, the method comprising determining interstation to intrastation interference factors independently of the total power transmitted by the given base station and by the neighboring base stations, said factors each being equal to the ratio of a path attenuation determined for an active link between a respective mobile terminal in a given position and the given base station to a sum of inverses of predetermined path attenuations between the respective mobile terminal in a given position and the neighboring stations, and estimating the total power transmitted by the given base station as a function of the sum of the determined interstation to intrastation interference factors.

2. Method as claimed in claim 1, further comprising:
(a) estimating the total powers transmitted by the neighboring base stations while considering that each neighboring base stations is a given base station;
(b) again determining the interstation to intrastation interference factors also as a function of the total powers transmitted by the given base station and by the estimated neighboring base stations, and
again estimating the total power transmitted by the given base station as a function of the previously determined interstation to intrastate interference factors.

3. Method as claimed in claim 2, further comprising replacing the signal to interference ratio for a downlink to said mobile terminal which depends on the total power transmitted by the given base station by the sum of signal to interference ratios that are determined for all the active downlinks to the mobile terminal operating in the macrodiversity mode, the replacing step being performed when a mobile operates in the macrodiversity mode, each determined signal to interference ratio depending on sums of downlink attenuation ratios relating to the active downlinks to the mobile terminal operating in the macrodiversity mode.

4. Method of estimating the total interference power received by a given base station in a CDMA type radiocommunications network as a function of the sum of received interference powers of channels dedicated to mobile terminals in given positions having active links with the given base station,
wherein the total interference powers received by the neighboring base stations are assumed to equal the total interference power received by the given base station neglecting the value of noise power of an active link, the method comprising determining intrastation to interstation interference factors independently of the total interference powers received by the given base station and by the neighboring base stations and depending each only on the previously determined path attenuations regarding the active links between the mobile terminals in given positions and the given base station and the active links between the mobile terminals in given positions and the neighboring base stations on a previously determined path attenuation in an active link between a respective mobile terminal in a given position and the given base station, and estimating the total interference power received by the given base station as a function of the determined interstation to intrastation interference factors.

5. A method as claimed in claim 4, further including estimating the total interference powers received by the neighboring base stations by considering each neighboring base station to be a given base station;
again determining the intrastation to interstation interference factors also as a function of the total powers received by the given base station and by the estimated neighboring base stations; and
again estimating the total interference power received by the given base station as a function of the previously determined intrastation to interstation interference factors.

6. Method as claimed in claim 1, further comprising replacing the signal to interference ratio for a downlink to said mobile terminal which depends on the total power transmitted by the given base station by the sum of signal to interference ratios that are determined for all the active downlinks to the mobile terminal operating in the macrodiversity mode, the replacing step being performed when a mobile operates in the macrodiversity mode, each determined signal to interference ratio depending on sums of downlink attenuation ratios relating to the active downlinks to the mobile terminal operating in the macrodiversity mode.
